(19) United States
(12) Patent Application Publication
(10) Pub. No.: US 2018/0153195 A1
(43) Pub. Date: Jun. 7, 2018

(54) SYSTEM AND METHOD TO COMBINE A FILTER SYSTEM WITH A FREEZE DRYER TO PREVENT CONTAMINATION OF A VACUUM PUMP

(71) Applicant: Jesse W. Rhodes, JR., Moncks Corner, SC (US)

(72) Inventor: Jesse W. Rhodes, JR., Moncks Corner, SC (US)

(21) Appl. No.: 15/833,271

(22) Filed: Dec. 6, 2017

Related U.S. Application Data
(60) Provisional application No. 62/431,212, filed on Dec. 7, 2016.

(51) Int. Cl. A23L 3/44; B01D 21/00; B01D 17/02; B01D 17/04; B01D 46/00; F25D 31/00

(52) U.S. Cl. CPC A23L 3/44; B01D 21/0012; B01D 17/0208; A23V 2002/00; B01D 46/0031; F25D 31/005; B01D 17/045

(57) ABSTRACT

A system and method for providing a filter to prevent contamination of a vacuum pump during use with a freeze dryer. The method comprises evacuating, with a vacuum pump, pressure from freeze dryer; monitoring level of oil in reservoir; circulating oil between a sedimentary filter and a coalescing filter, and the vacuum pump, whereby a low pressure generated by the vacuum pump enables flowage of the oil; collecting condensation and water vapor that evaporates from oil through an exhaust hose; collecting, in the sedimentary filter, rust, particulates, and water from oil; collecting, in coalescing filter, water vapor and particulate gas to coalesce water vapor and particulate gas into oil, water, and particulates; separating, in coalescing filter, oil from water and particulates, whereby oil is rejuvenated; injecting clean air into rejuvenated oil; and turning the vacuum off and allowing remaining oil in the static system to return to vacuum pump reservoir.

### CROSS REFERENCE OF RELATED APPLICATIONS

This application claims the benefits of U.S. provisional application No. 62/431,212, filed Dec. 7, 2016 and entitled FILTER SYSTEM TO ELIMINATE RUST, WATER AND PARTICULATE RESIDUE FROM ENTERING THE VACUUM PUMP USED WITH A FREEZE DRYER, which provisional application is incorporated by reference herein in its entirety.

### BACKGROUND OF THE INVENTION

The present invention relates generally to a process and method for providing a filter to prevent contamination of a vacuum pump used with a freeze dryer. Freeze dryers use vacuum pumps. The pumps are designed to be used on air conditioners they contain ferrous metal parts, and work fine. However when used in the application of a freeze dryer the rust contaminates the system and causes problems in operation. After use the vacuum pumps become full of rust water and particulate. In order to keep the system operational after normal use it takes hours to clean and to re-lubricate the system with large amounts oil.

People have tried to solve this problem in the past by using a vacuum pumps' motor to move the oil through a 7 micron car oil filter at a rate of six cubic feet of oil per minute. As you would expect the pumps' reservoir had extremely high pressure. There were several mishaps reported such as sight glasses blowing out and reservoir covers ruptured because of the extreme pressure.

Another design in an attempt to filter contaminated oil was to simply circulate the oil from the vacuum pumps' drain through a filter and back into the oil fill which necessitated the use of an additional pump and filter, however it failed to clean all of the oil and internal parts of the pump.

Thus there is a long felt need for a filter system to circulate the clean oil and air through out the entire vacuum pump and to clean rust and particulate residue contamination from a vacuum pump when used with a freeze dryer.

### SUMMARY OF THE INVENTION

The present disclosure generally comprises a system and method for providing a filter to prevent contamination of a vacuum pump during use with a freeze dryer. The filter system for filtering an oil composition in a vacuum pump used with a freeze dryer, comprising: a vacuum pump connected to a freeze dryer through a vacuum hose, the vacuum pump evacuating pressure from the freeze dryer, the vacuum pump comprising a reservoir containing an oil composition; an oil recirculation hose that provides a path for the oil from the vacuum pump reservoir through a sedimentary filter into the core of a coalescing filter; wherein the coalescing filter at least partially collects water vapor and the particulate gas, the coalescing filter further coalescing the water vapor, and the particulate gas into oil, water, and particulates, whereby the particulates in the particulate gas are at least partially separated from the gas, the coalescing filter further separating the oil from the water and particulates, whereby the oil is rejuvenated for use with the oil composition; an oil control valve to control pressure in the system and maintain a level of oil in the vacuum pump; a filter drain enabling selective passage of the rejuvenated oil from the coalescing filter to the reservoir in the vacuum pump; a vent and an exhaust hose injecting clean air into the rejuvenated oil; and a return hose returning the rejuvenated oil to the reservoir of the vacuum pump.

The method for filtering an oil composition in a vacuum pump used with a freeze dryer, comprising: freezing a medium in a freeze dryer; switching a transition switch to a freeze drying mode; evacuating, with a vacuum pump, pressure from the freeze dryer through a vacuum hose, the vacuum pump comprising a reservoir containing an oil composition, whereby the frozen medium sublimates from a solid to a sublimated gas, whereby the sublimated gas migrates from the freeze dryer into the oil composition in the vacuum pump to form a particulate gas mixed with the oil composition; monitoring, through a reservoir sight glass, the level of the oil composition in the reservoir of the vacuum pump; waiting a predetermined time for the vacuum pump to cool (a temperature in a range of about 60° to 80° F., depending on the amount of particulates in the oil) switching the transfer switch to a filter mode; opening an oil flow control valve; circulating the oil composition between the coalescing filter, the sedimentary filters and the vacuum pump, whereby low pressure generated by the vacuum pump enables flowage of the oil composition; at least partially collecting condensation and water vapor that evaporates from the oil composition through an exhaust hose; at least partially collecting, in a sedimentary filter, rust, particulates, and water from the oil composition; at least partially collecting, in a coalescing filter, water vapor and the particulate gas; coalescing, in the coalescing filter, the water vapor, and the particulate gas into oil, water, and particulates, whereby the particulates in the particulate gas are at least partially separated from the gas; separating, in the coalescing filter, the oil from the water and particulates, whereby the oil is rejuvenated for use with the oil composition; injecting clean air from a vent and an exhaust hose into the rejuvenated oil; at least partially collecting, in the sedimentary filter, water from the rejuvenated oil; returning, through a return hose, the rejuvenated oil to the reservoir of the vacuum pump; closing the oil flow control valve; and switching the transition switch to the freeze drying mode.

A general object of the present disclosure is to provide a system and method for filtering an oil composition in a vacuum pump.

Still another object of the present disclosure is to provide a filtration system used with a freeze dryer to eliminate contamination of rust, water and gas particulate residue from a vacuum pump used with a freeze dryer.

Still another object of the present disclosure is to provide a filtration system that will collect water vapor and particulate gasses and coalesce the water vapor and particulate gasses back into oil, water and particulates, trapping the water and particulate and returning the oil back to the vacuum pump without the need to drain or replace the oil.

Still a further object of the present disclosure is to provide a filter system that has a transfer switch that will move power and control of the vacuum pump from the freeze dryer to an alternative power source.

Still another object of the present disclosure is to provide a filter system that eliminates the exhaust of oil gas and oil mist.

Still a further object of the present disclosure is to provide a filter system that filtration cycle can occur during a freezing cycle of a freeze dryer.

Still another object of the present disclosure is to provide a filter system that uses a mixture of air and oil also helps absorb water from the oil into the air bubbles and remove particulate.

Still a further object of the present disclosure is to provide a filter system that significantly lowers the noise level of a vacuum pump during use with a freeze dryer.

Still another further object of the present disclosure is to make the combination of a vacuum pump used with a freeze dryer compatible and easy to install and operate.

Still another object of the present disclosure is to provide a filter system that makes automotive and home air conditioner vacuum pumps compatible with freeze dryers.

Still a further object of the present disclosure is to provide a filter system that makes a freeze dryer compatible with a rotary vane vacuum pump.

Other systems, devices, methods, features and advantages of the disclosure will be further understood and appreciated by those skilled in the art by reference to the following written specification, claims and appended drawings.

It is intended that all such additional systems, methods, features, and advantages be included within this description, be within the scope of the present disclosure, and be protected by the accompanying claims.

### BRIEF DESCRIPTION OF THE DRAWINGS

FIG. 1 is a view of a filter system of the present disclosure.

FIG. 2A is a diagram showing a non-limiting embodiment of the electrical circuit of the filter system of the present disclosure in filter mode.

FIG. 2B is a diagram showing a non-limiting embodiment of the electrical circuit filter of the filter system of the present disclosure in freeze drying mode.

FIG. 2C is a diagram showing another non-limiting embodiment of the electrical circuit of the filter system of the present disclosure in filter mode.

FIG. 2D is a diagram showing another non-limiting embodiment of the electrical circuit of the filter system of the present disclosure in freeze drying mode.

FIG. 3A is a sectional view of a filter system of the present disclosure showing the flow directions of the air in the filter system of the present disclosure in freeze drying mode.

FIG. 3B is a sectional view of a filter system of the present disclosure showing the flow directions of the air and oil the filter system of the present disclosure in filter mode.

FIG. 3C is a sectional view of a filter system of the present disclosure showing the flow directions of the oil settling in filter mode.

FIGS. 4A and 4B are flowcharts showing the steps of an exemplary method for filtering an oil composition in a vacuum pump used with a freeze dryer.

### DETAILED DESCRIPTION OF THE INVENTION

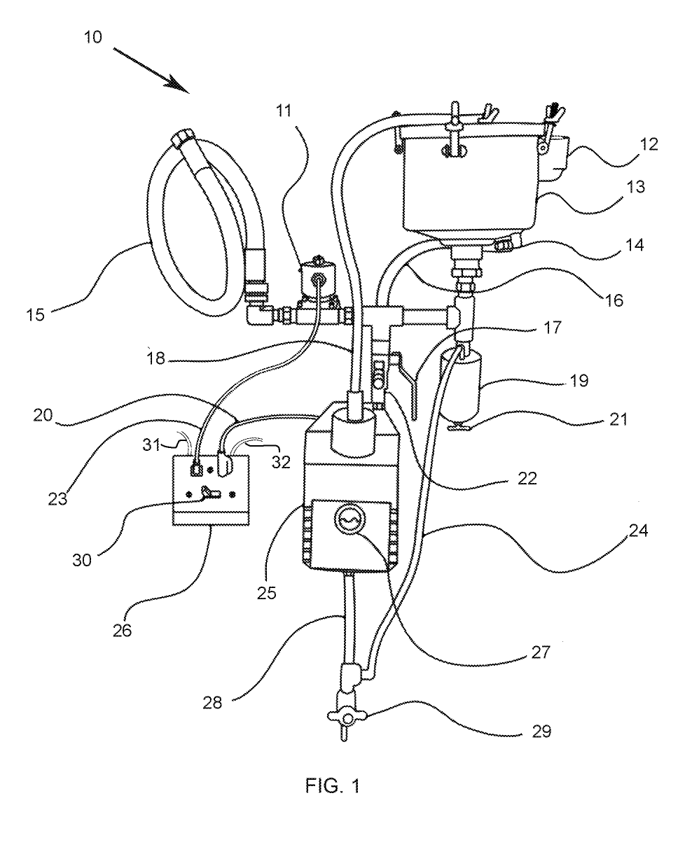

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Currently it is known that freeze dryers require a deep vacuum and commonly use a vacuum pump that is designed to be used on a dry system (such as with air conditioners) that contain ferrous metal parts. Typically a rotary vane pump is used to create the needed vacuum, however these vacuum pumps are designed for dry systems and do not tolerate water. As a result the pump collects water vapor and particulate gases while maintaining a vacuum on a freeze dryer. In order to keep the system operational it is necessary to perform hours of cleaning and to re-lubricate the system with large amounts oil.

There are two basic cycles when using a freeze dryer and a vacuum pump: a nine hour freezing cycle and a freeze drying cycle. The purpose of the freezing cycle is to cool the drum of the freeze dryer to −40-to −80 degrees Fahrenheit to prevent the food product from gassing during the vacuuming process and to get the freeze dryer drum as cold as possible. The food will also freeze, although when the next cycle starts, (freeze drying) the food temperature is heated and lowered to maximize sublimation. The vacuum pump is not used while the freeze dryer is in the freezing cycle.

The second cycle is the freeze drying cycle. The vacuum pump is turned on pulling a deep vacuum and the heater under the food is turned on causing the frozen liquid in the food to sublimate. The frozen food can not melt while in a vacuum. The frozen liquid in the food will go from a solid directly to a gas. When the gas comes in contact with the cold walls of the freeze dryer drum, it de-sublimates into a solid. The result is freeze dried food.

During this process the gasses are expanding causing loss of vacuum pressure. The vacuum pump is kept running to maintain a vacuum. Some sublimated gasses will migrate from the freeze dryer through the connecting vacuum hose, in its deep vacuum environment into the oil of the vacuum pump. The environment in the oil is not a vacuum and its temperature is too cold to cause the gasses to sublimate and too hot to cause de-sublimation.

These gasses are trapped in the oil in the vacuum pump when the environment changes to no vacuum and 160 degrees Fahrenheit. The water vapor and particulate gasses will stay there until it is either heated to evaporate or cooled to de-sublimate. The other alternatives are to remove the oil from the pump while it's hot and filter it or replace it. If the water vapor and particulate is left in the pump it will cause rust and of course will collect water and the de-sublimated elements from the food.

The only alternative to clean the system is to remove the oil from the vacuum pump while it's hot and either replace it or wait until the oil temperature is cold enough to filter. If left in the pump it will cause major contamination such as rust from ferrous parts, water and particulate. Particulate is nothing more than certain elements that sublimate from food.

Also it should be noted that vacuum pumps are made for outside use and are very noisy, and have a problem with oil mist and spray coming from the pumps exhaust. If the pump is overfilled it can spray oil out from the intake. Also if left unattended after the final dry cycle oil can escape. The pump's check valve can fail and oil can contaminate the freeze dryer through the vacuum hose. Clearly there is a long felt need for a system to eliminate both rust and particulate residue to prevent contamination of a freeze dryer from a vacuum pump.

The present disclosure generally comprises a system and method for providing a filter system to prevent contamination of a vacuum pump during use with a freeze dryer.

Averting to the drawings, with reference to FIG. 1 illustrates a filter system 10 of the present disclosure comprising a vacuum pump 25 connected to a freeze dryer 40 (shown in FIG'S. 3A and B) by vacuum hose 15, a sedimentary filter 19 and a coalescing filter 13. Sedimentary filter 19 collects rust, particulates and water as the oil is moved through it when it's in a filtration cycle. Sedimentary filter 19 has a petcock drain 21 that is used to periodically drain collected contaminates.

The filter system for filtering an oil composition in a vacuum pump used with a freeze dryer, comprising: a vacuum pump comprising a check valve and a reservoir containing an oil composition, the vacuum pump operationally connected to a freeze dryer through a vacuum hose, the vacuum pump evacuating pressure from the freeze dryer; a sedimentary filter;

a coalescing filter comprising a core; an oil recirculation hose circulating the oil composition from the reservoir through the sedimentary filter and into the core of the coalescing filter; wherein the coalescing filter at least partially collects water vapor and the particulate gas, the coalescing filter further coalescing the water vapor, and the particulate gas into oil, water, and particulates, whereby the particulates in the particulate gas are at least partially separated from the gas, the coalescing filter further separating the oil from the water and particulates, whereby the oil is rejuvenated for use with the oil composition; a reed valve operational in the vacuum pump, the reed valve enabling passage of the oil composition and clean air for generating pressure in the reservoir of the vacuum pump; an oil control valve controlling the generated pressure to a predetermined pressure during circulation of the oil composition, the oil control valve further maintaining the oil composition at a predetermined level in the vacuum pump;
a filter drain enabling selective passage of the rejuvenated oil from the coalescing filter to the reservoir in the vacuum pump; a vent enabling passage of the clean air into the rejuvenated oil;
an exhaust hose in communication with the vent, the exhaust hose carrying the clean air to the rejuvenated oil; a return hose returning the rejuvenated oil to the reservoir of the vacuum pump;
a transfer switch for switching the system between a freeze drying mode and a filter mode; a first power source powering the system in the freeze drying mode; and a second power source powering the system in the filter mode.

Filtration is performed after the freeze drying cycle and when the pump and oil have had a chance to cool to a pre-determined temperature so that de-sublimation can occur. The short period of time it takes for the temperature change will not be sufficient to contaminate the pump. Filtration can be performed with the freeze dryer off or in a freezing mode as long as the temperature of the oil in the pump is at about room temperature. The water and particulate vapor that migrated through vacuum hose 15 into the oil is now trapped in the oil due to the environmental change. As long as the oil is at a temperature where the particulates are in a gaseous state (sublimated) the oil can not be filtered. High temperature will cause sublimation, decreasing the temperature will cause de-sublimation (a temperature in a range of about 60° to 80° F., depending on the amount of particulates in the oil). Once the gasses have returned to their original state they can be filtered and removed, leaving the oil clean.

Filtration mode begins once transfer switch 30 is moved from freeze drying mode position to filter mode and oil flow control valve 17 is open. Oil flow control valve 17 can be left full open or adjusted for noise and oil flow rate.

Exhaust hose 18 collects and recycles condensation being evaporated from the oil during the entire drying cycle. The exhaust hose provides a path to exhaust the air drawn into the vacuum pump into the inner core of the sedimentary filter 19, through coalescing filter 13 and out of vent 12. Return hose 16 provides a path for the clean filtered oil and air back to the vacuum pump.

Oil flow control valve 17 is used to turn on the oil flow and controls the flow rate. When the system is in freeze dry mode oil flow control valve 17 is closed. When the system is in filter mode oil flow control valve 17 is open. While the freeze dryer is in a freeze cycle, the transfer switch 30 needs to be positioned to filter mode and the oil drain valve 29 is positioned to open.

There are two sources of power to the transfer switch 30. When in freeze drying mode the power is supplied from freeze dryer first power source 31. When in filtering mode, power is supplied from second power source 32. When transfer switch 30 is in the freeze drying position the freeze dryer is in control. When the freeze dryer is in its nine hour freezing cycle, power to electrically operated valve 11 and vacuum pump 25 is turned off.

The function of coalescing filter 13 is to coalesce oil vapor back into oil keeping out of the environment. Coalescing filter 13 will also let water vapor escape through vent 12 or if the oil is condensed it will be trapped by the sedimentary filter 19 as the oil settles back into the vacuum pump. Coalescing filter 13 is preferably a 0.3 micron coalescing type filter that will collect oil mist, smoke or oil that may be ejected from the exhaust and return it to a reservoir in vacuum pump 25.

Coalescing filter 13 also causes the water vapor and condensation to condense back to water to be trapped. Particulates and rust are filtered out of the oil and are trapped in the sedimentary filter 19. Coalescing filter 13 will also reduces the noise created by the vacuum pump. With the coalescing filter installed the noise level is significantly reduced thus allowing users to keep their freeze dryer and vacuum pump indoors with their other appliances.

Vacuum pump 25 has a reservoir sight glass 27 used to monitor the oil level in the reservoir. Drain hose 28 and drain valve 29 is used remove oil if the level oil is above the sight glass 27 in vacuum pump 25. Oil recirculation hose 24 provides a path for the oil from the vacuum pump reservoir through the sedimentary filter into the core of the coalescing filter.

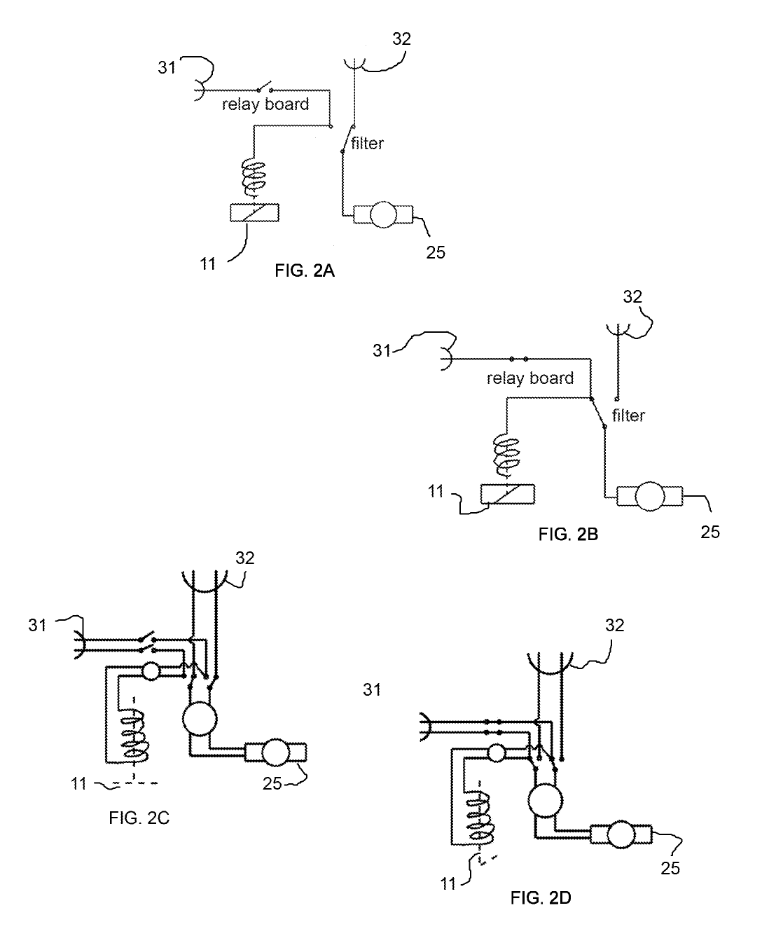

FIGS. 2A and 2B are wiring diagrams for 120 VAC 60 Hertz filtration system. FIG. 2a is a diagram showing a non-limiting embodiment of the electrical circuit of the filter system of the present disclosure in filter mode. FIG. 2A shows the condition of the 120 VAC circuits in filter mode with the freeze dryer in freezing mode while filtering. First power source 31 is provided and controlled by logic circuits and a relay in the freeze dryer. It is actually plugged into the back of the freeze dryer. It turns electrically operated valve 11 and vacuum pump 25 off during freezing cycle for nine hours. Filtration should be performed only after the pump has cooled. When the system is switched to filter mode by transfer switch 30, vacuum pump 25 is powered by second power source 32. Electrically operated valve 11 is kept in the off position by the open side of transfer switch 30. Because of its reverse configuration a certain amount of vacuum can be achieved while running in filter mode through the closed valve. It's just enough to seal the freeze dryer preventing failure to achieve a vacuum due to ice forming under its gasket causing leaks.

When in filter mode, the power is applied to the vacuum pump through the transfer switch 30 from power box 26 through power cord 20. Electrically operated valve 11 is off and remains closed until the power is applied to the electrically operated valve 11 through the transfer switch 30 from power box 26 through power cord 23.

FIG. 2B is a diagram showing a non-limiting embodiment of the electrical circuit filter of the filter system of the present disclosure in freeze drying mode. FIG. 2B illustrates the condition of the 120 VAC circuits in freeze drying mode. After filtering is complete transfer switch 30 is moved back to the freeze drying position. Electrically operated valve 11 and vacuum pump 25 are turned on by the freeze dryer relay during drying. After the final dry is completed the freeze dryer relay turns off the electrically operated valve 11 and vacuum pump 25.

In freeze dryer mode the vacuum pump 25 is turned on to pull a vacuum and power is supplied to electrically operated valve 11 which remains closed until it receives power and is opened to provide a path to the vacuum chamber. At the end of final dry cycle the relay board drops power to the electrically operated valve and turns off the vacuum motor. The vacuum pump has a check valve to prevent the freeze driver from sucking the oil from the vacuum pump into the freeze dryer. If the vacuum does not decrease, then the vacuum may slowly decrease from gassing or leaks. At some point the check valve will fail and what ever vacuum is left will suck the oil into the vacuum chamber. The normally closed electrically operated valve 11 will prevent this failure.

FIGS. 2C and 2D illustrate wiring diagrams for 220 VAC 60 Hertz filtration system. FIG. 2C is a diagram showing another non-limiting embodiment of the electrical circuit of the filter system of the present disclosure in filter mode. FIG. 2D is a diagram showing another non-limiting embodiment of the electrical circuit of the filter system of the present disclosure in freeze drying mode. FIGS. 2C and 2D show a similar configuration as 2A and 2B however the electrical circuit diagrams shown in FIGS. 2C and 2D are for large freeze dryers having 220 VAC. In these larger systems the filter configuration is the same as in the smaller system.

FIG. 2C is a diagram showing another non-limiting embodiment of the electrical circuit of the filter system of the present disclosure in filter mode. In filtration mode the relay is dropped allowing normally closed electrically operated valve 11 to close. The vacuum pump is powered from a power cord 20, during filtration mode. When in filter mode, the power is applied to the vacuum pump through the transfer switch from power cord 20.

FIG. 2D is a diagram showing another non-limiting embodiment of the electrical circuit of the filter system of the present disclosure in freeze dry mode. When switching to freeze dryer mode, power is applied to vacuum pump 25 and the electrically operated valve 11 from the freeze dryer.

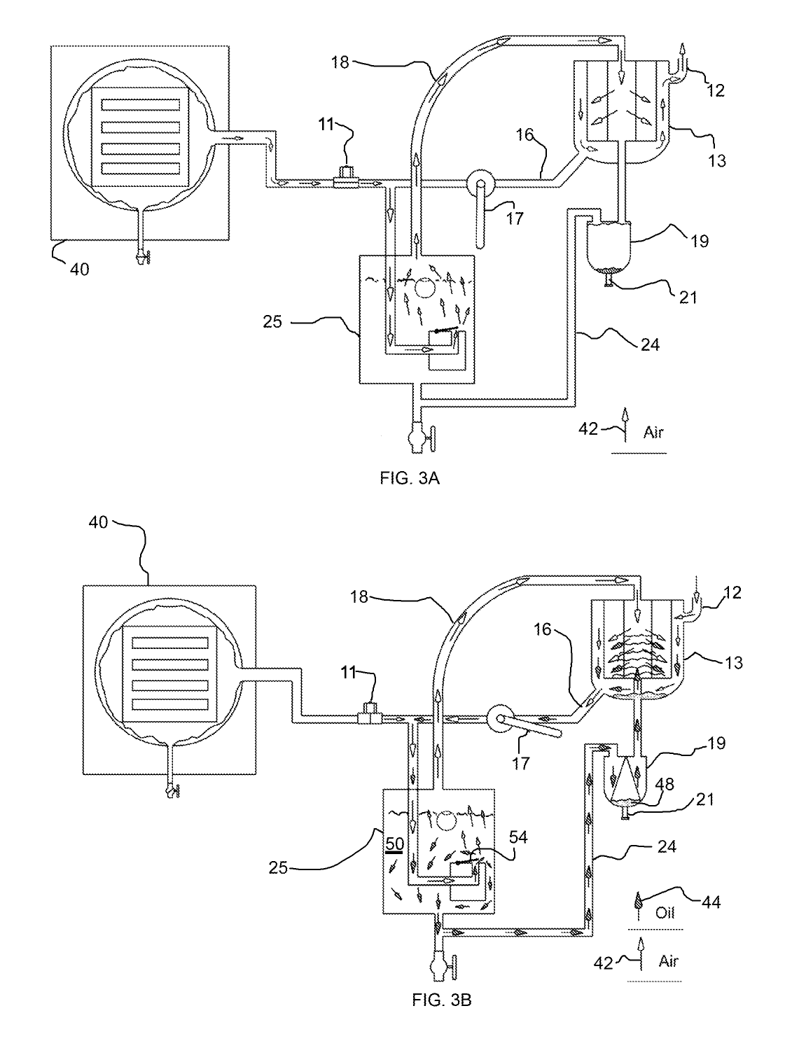

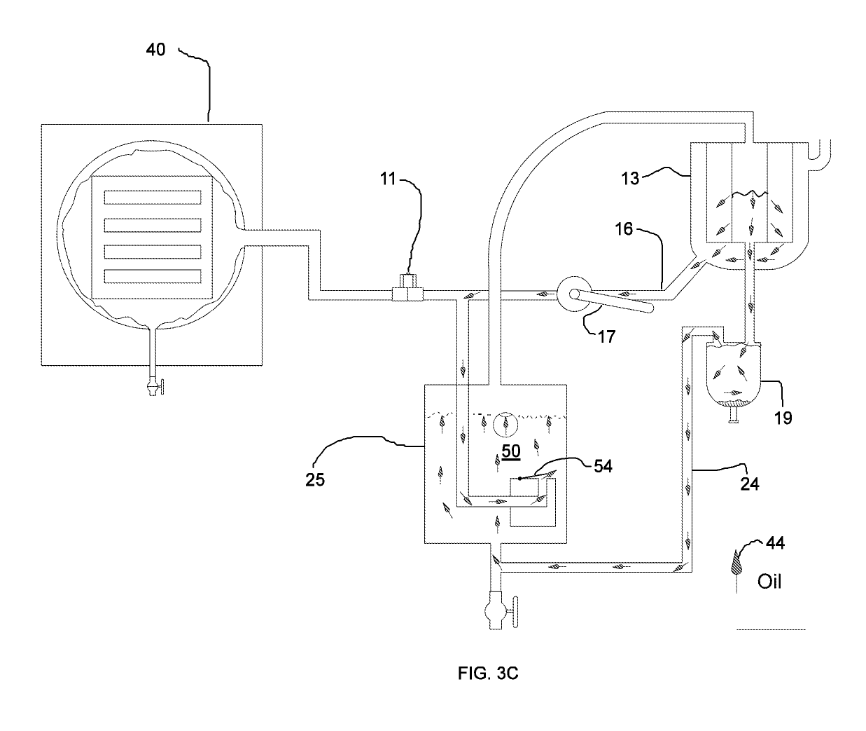

FIG. 3A is a sectional view of a filter system of the present disclosure showing the flow directions of the air in the filter system of the present disclosure in freeze drying mode. Using the present configuration in freeze drying mode once the product is loaded into the freeze dryer 40 it is frozen for nine hours it should reach a temperature of −40 to −80 degrees Fahrenheit. Vacuum pump 25 is turned on, pulling a deep vacuum. Heaters are turned on under the product raising and lowering its temperature “annealing” causing water and certain other elements in the food to sublimate (the food product goes directly from a solid to a gas). When these gases come in contact with the vacuum chambers wall it de-sublimates turning back into a solid ice. During this process the food is gassing, causing loss of vacuum. The vacuum pump 25 maintains the vacuum. During this process the vacuum and temperature will raise and lower causing maximum sublimation.

The vacuum chamber, the drain line and the vacuum hose 15 that connects the freeze dryer to the vacuum pump, all share the same environment. This environment will not support any liquid elements. Only gasses will travel through the vacuum hose into the pumps oil. Once these gasses enter the oil, the environment changes the gasses are suspended in the oil and will remain there until it changes. If the oil is allowed to cool the gasses will return to their original state, contaminating the pump. Once the freeze drying cycle is completed and the oil temperature has decreased to room temp the system is ready for the filtering mode. Filtration is performed completely separate from freeze drying.

FIG. 3B is a sectional view of a filter system of the present disclosure showing the flow directions of the air and oil the filter system of the present disclosure in filter mode. After a lengthy drying cycle the freeze dryer switches to a final dry mode. The heaters are turned on to remove any remaining ice. The freeze dryer then turns off. The oil has a chance to cool and then the filtering mode can begin. The incompatibility between the vacuum pump and the freeze dryer produces an excess of water vapor and particulate (gases) that migrate into the vacuum pumps oil. Filter system 10 removes these gasses from the freeze dryers oil. In the freeze drying mode any gasses that pass through reed valves 54 and oil that are not trapped will evaporate through the filter system vent 12.

Running the system in filter mode (after the oil has been allowed cool in the vacuum pump) will move the contaminated oil through sedimentary filter 19, removing any water and particulates that may have formed in vacuum pump 25. The oil is then moved into the core of coalescing filter 13 (preferably a 0.3 micron filter) causing the trapped water and particulates to coalesce back to water and particulate as it passes through the filter element.

Pressure will cause oil 44 to move up into the bottom of the inner core of coalescing filter. The water and particulate gasses that are trapped in the oil are de-sublimated as the oil cools returning the particulate gasses to the original state of water and whatever elements the particulates were before it was sublimated. As the water and particulates are pushed through the coalescing filter by exhaust gasses, the water will evaporate or be coalesced into water droplets. Particulates turns into multi-color jell and other unknown particles. As the oil returns to the reservoir the water and particulates are trapped by the sedimentary filter. As the air and clean filtered oil 44 comes through the coalescing filter it is moved through the system again by the pressure of the vacuum.

After oil 44 comes through the coalescing filter 13 it is clean and pulled into the vacuum intake block 22 (see FIG. 1). As this is happening the system also pulls air from vent 12. The air and oil mix together and is pulled through the reed valves 54 moving oil 44 (oil that has been filtered and is free of particulates) and air through vacuum pump 25. The air tends to mix with the water vapor helping with filtering. The oil is circulated by the vacuum pumps exhaust from its vacuuming action. It pulls clean air and filtered clean oil 44 from the coalescing filters drain after being filtered and fresh air from its vent 12. This mixture of air and clean oil 44 moves through return hose 16, through oil flow control valve 17 into the vacuums pumps rotating vanes 52, through its reed valves and into the pumps oil reservoir 50. This causes pressure to build in the reservoir but only as much as allowed by the closed or open position of oil flow control valve 17.

Pressure is built in the reservoir as clean oil and air is available. It can only develop as much pressure as the amount of oil being filtered and moved into the reservoir. As the pressure increases it pushes air up into the center core of the coalescing filter and oil into the bottom of the center core of the coalescing filter. As the air and oil is filtered at its own rate “through the 0.3 micron filter” it keeps the pressure under control.

Turning the oil control valve off can only cause the vacuum pump to pull a vacuum, what it is designed to do. The pressure is adjusted by the oil control valve to keep the reasonable level of oil in the pump. This pressure moves unfiltered oil 44 from the reservoir 50 up through the oil recirculation hose 24 into the sedimentary filter where any rust, water, or de-sublimated elements are removed. As the air and oil comes through reed valve 54 into the pump's reservoir 50, it creates a pressure in the reservoir. The amount of pressure is controlled by oil flow control valve 17. If the valve is closed, no oil can flow which results in zero pressure. If the valve is opened fully the pressure generated is limited by the amount of air and oil allow to flow. This pressure control makes the system safe to operate. Other systems being sold are not vented and only oil is circulated at 6 cubic feet of oil per minute. Oil of course does not compress and will explode the pump.

After oil 44 is filtered it is returned back to the pump's reservoir 50 through filter drain 14 (see FIG. 1), through the return hose 16, through oil flow control valve 17 into the vacuum pump's intake, through the pump's check valve, through the pump vanes and out of the pumps reed valves 54 and back into the pump's reservoir 50. In short the oil composition that is filtered comes out of, or through vacuum pump 25.

Using the vacuum pump 25 to move the oil through coalescing filter 13 safely is accomplished by the vacuum pressure in the system pushing the oil and clean air from the outer core of the filter and through all parts of vacuum pump 25 at a very low pressure less than 2500 Torr. The oil level can be viewed through the sight glass to determine the amount of rejuvenated oil that has returned to vacuum pump.

The controlled oil pressure in the reservoir 50 pushes exhaust air carrying moisture up and into the core of coalescing filter 13. At the same time the pressure pushes pre-filtered (dirty) oil 44 from vacuum pump's drain up and into the core of sedimentary filter 19. The oil 44 and air are moved through the coalescing filter and is sucked back into the pump through vacuum intake block 22 (see FIG. 1). As the oil moves from reservoir 50 to the coalescing filter and back to the reservoir it passes through the sedimentary filter 19. Any water that did not evaporate along with any de-sublimated particulate is trapped in the sedimentary filter. When this process is completed dirty oil becomes clean oil 44 and the oil is crystal clear. After the oil is cleaned the system can be returned to freeze dry mode by allowing the oil to flow back into the reservoir and closing oil flow control valve 17. The freeze dryer continues with its process as usual. Sediment and collected contaminates 48 are removed by periodically draining sedimentary filter 19 through petcock drain 21.

In essence, the system and method circulates oil composition from the coalescing filter, through the pump, into the reservoir and back through the sedimentary filter, removing water, particulates and any rust picked up in the pump and on into the core of the coalescing filter, through the filter element and back to be picked up again. Also when the filtration cycle is ended, the oil is drains back through the sedimentary filter removing any water, particulates, and rust caught or coalesced by the coalescing filter.

During the freeze drying process the pumps oil is acts as a filter, collecting any water vapor or particulate gasses that migrate through the vacuum line while trying to maintain a vacuum while the freeze is sublimating (giving off gas). It is significant to note that the vacuum pump is only used for filtering when it is not being used by the freeze dryer. The filtration cycle of the vacuum pump is independent from freeze drying. The transfer switch removes the power source for the vacuum pump from the freeze dryer. The electrically operated valve closes the vacuum line. In this manner, the oil control valve allows the vacuum pump to vacuum the clean oil coming for through the coalescing filter, also it mixes clean air with clean oil.

Further, the vanes rotate and pull the oil and air into the pump reservoir, creating a pressure equal to the amount of oil that is filtered. The oil composition and clean air is released by the reed valves under the surface of the oil. It is significant to note that allowing the oil composition to cool to room temperature causes de-sublimation. Also, the oil will cloud if there is contamination, filter until clean. During installation of the system, the oil level should be set so that when filtering, it stays in the site glass. This insures that the pressure does not exceed the pressure required to move the oil composition. Also it insures that there is enough oil is in the pump to prevent damage.

In other words the clean oil and some air is being picked up as it comes out of the coalescing filter, and being moved into the pumps oil reservoir causing the air to be displaced and pushed into the top core of the coalescing filter. The oil composition is displaced and pushed into the bottom core of the coalescing filter. The coalescing filter displaces as much air and oil as it filters. The configuration of the coalescing filter is vented to help in this cause. The system measures from zero and varies up to what is required to move the amount of that the filter can filter. The filter is preferably a 0.3 micron coalescing filter.

FIG. 3C is a sectional view of a filter system of the present disclosure showing the flow directions of the oil settling in filter mode. After the filter cycle is ended, the water and particulate removed from the oil is trapped by sedimentary filter 19 while draining back into vacuum pump 25. When the filtering cycle is completed the vacuum is turned off to allow the remaining oil in the static system to return to the reservoir of the vacuum pump. Gravity allows the sedimentary and rejuvenated oil to settle. The oil can then be viewed through the sight glass in the reservoir of the vacuum pump to determine quantity and cleanliness of oil. Once the oil has settled the system is placed in freeze dry mode by closing the oil flow control valve and switching the transition switch to the freeze drying mode position.

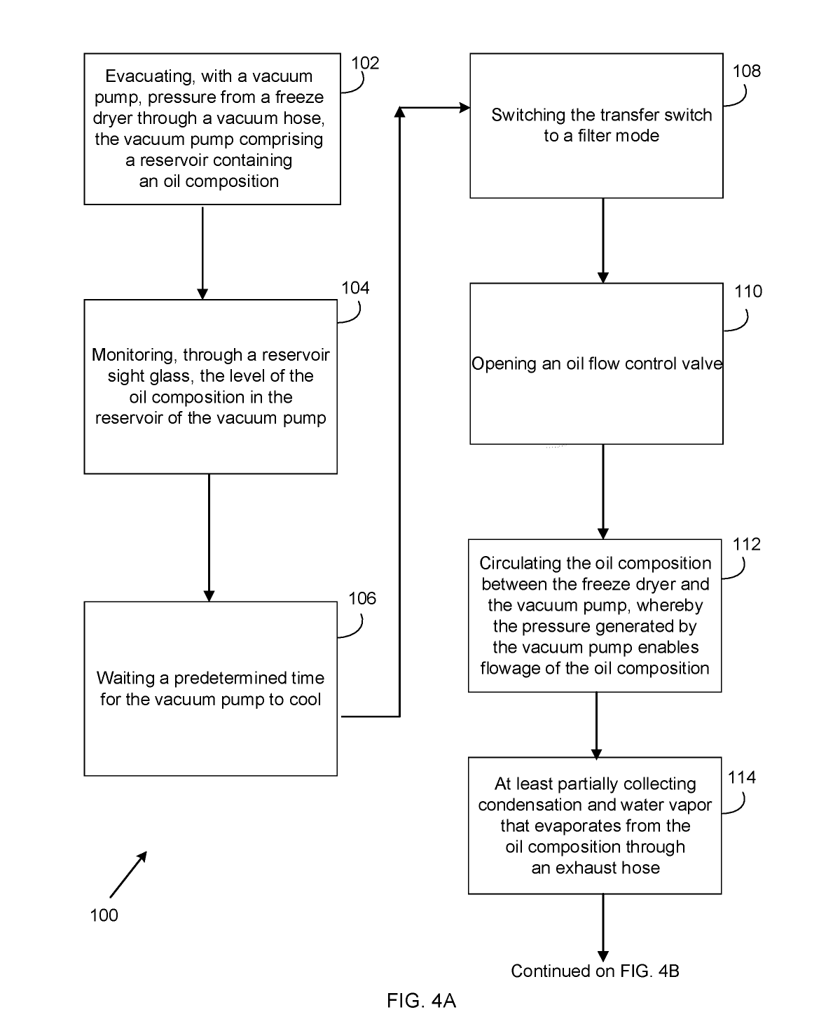

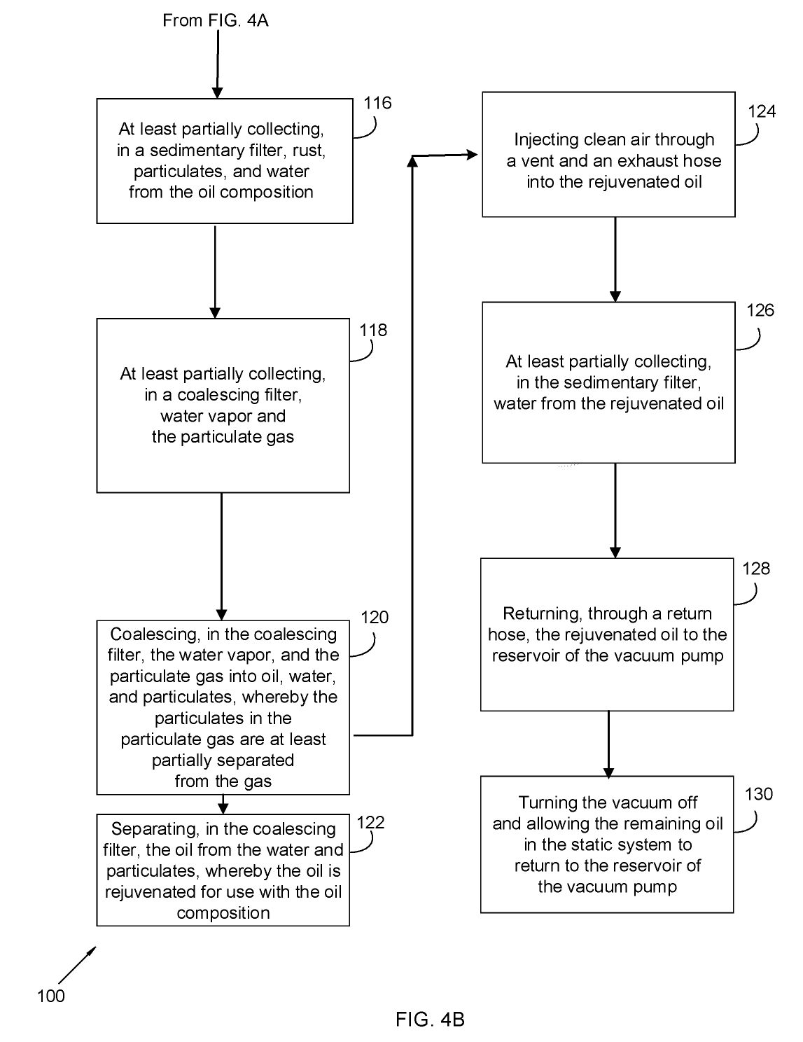

FIGS. 4A and 4B reference flowcharts showing the steps of an exemplary method 100 for filtering an oil composition in a vacuum pump used with a freeze dryer, the method comprising: evacuating, with a vacuum pump, pressure from a freeze dryer containing a frozen medium through a vacuum hose, the vacuum pump comprising a reservoir containing an oil, whereby the frozen medium sublimates from a solid to a sublimated gas, whereby the excess sublimated gas migrates from the freeze dryer into the oil in the vacuum pump to form a particulate gas and water vapor mixed with the oil and trapped in the vacuum pump; monitoring, through a reservoir sight glass, a predetermined level of the oil composition in the reservoir of the vacuum pump; waiting a predetermined time for the vacuum pump to cool; switching the transfer switch to a filter mode; opening an oil flow control valve; circulating the oil throughout the vacuum pump, whereby the pressure generated by the vacuum pump enables flowage of the oil; at least partially collecting condensation and water vapor that evaporates from the oil through an exhaust hose; at least partially collecting, in a sedimentary filter, rust, particulates, and water from the oil; at least partially collecting, in a coalescing filter, water vapor and the particulate gas; coalescing, in the coalescing filter, the water vapor, and the particulate gas into oil, water, and particulates, whereby the particulates in the particulate gas are at least partially separated from the gas; separating, in the coalescing filter, the oil from the water and the particulate gas s, whereby the oil is rejuvenated; injecting clean air through a vent and an exhaust hose into the rejuvenated oil; at least partially collecting, in the sedimentary filter, water from the rejuvenated oil; returning, through a return hose, the rejuvenated oil to the reservoir of the vacuum pump; and turning the vacuum off and allowing the remaining oil in the static system to return to the reservoir of the vacuum pump.

The method 100 may include an initial Step 102 of evacuating, with a vacuum pump, pressure from a freeze dryer containing a frozen medium through a vacuum hose, the vacuum pump comprising a reservoir containing an oil composition, whereby the frozen medium sublimates from a solid to a sublimated gas, whereby the sublimated gas migrates from the freeze dryer into the oil composition in the vacuum pump to form a particulate gas mixed with the oil composition. The method 100 may further comprise a Step 104 of monitoring, through a reservoir sight glass, the level of the oil composition in the reservoir of the vacuum pump. A Step 106 includes waiting a predetermined time for the vacuum pump to cool.

In some embodiments, a Step 108 comprises switching the transfer switch to a filter mode. A Step 110 includes opening an oil flow control valve. The valve may include a hand operated ball valve known in the art. A Step 112 may include circulating the oil composition between the filters and the vacuum pump, whereby the pressure generated by the vacuum pump enables flowage of the oil composition. The pressure in the oil reservoir is determined by how much oil/air is available, which is controlled by the filtering rate. In essence, oil is circulated from the coalescing filter, through the pump, into the reservoir and back through the sedimentary filter, removing water, particulates and any rust picked up in the pump and on into the core of the coalescing filter, through the filter element and back to be picked up again. Also when the filtration cycle is ended, the oil is drains back through the sedimentary filter removing any water, particulates, and rust caught or coalesced by the coalescing filter.

In some embodiments, a Step 114 comprises at least partially collecting condensation and water vapor that evaporates from the oil composition through an exhaust hose. Another Step 116 may include at least partially collecting, in a sedimentary filter, rust, particulates, and water from the oil composition. The method 100 may further comprise a Step 118 of at least partially collecting, in a coalescing filter, water vapor and the particulate gas. A Step 120 includes coalescing, in the coalescing filter, the water vapor, and the particulate gas into oil, water, and particulates, whereby the particulates in the particulate gas are at least partially separated from the gas.

In some embodiments, a Step 122 comprises separating, in the coalescing filter, the oil from the water and particulates, whereby the oil is rejuvenated for use with the oil composition. A Step 124 includes injecting clean air through a vent and an exhaust hose into the rejuvenated oil. In some embodiments, a Step 126 may include at least partially collecting, in the sedimentary filter, water from the rejuvenated oil. A Step 128 comprises returning, through a return hose, the rejuvenated oil to the reservoir of the vacuum pump. A final Step 130 includes turning the vacuum off and allowing the remaining oil in the static system to return to the reservoir of the vacuum pump. This allows the sedimentary and rejuvenated oil to settle. The oil can then be viewed through the sight glass in the reservoir of the vacuum pump to determine quantity and cleanliness of oil.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method for filtering an oil composition in a vacuum pump used with a freeze dryer, the method comprising:
evacuating, with a vacuum pump, pressure from a freeze dryer containing a frozen medium through a vacuum hose, the vacuum pump comprising a reservoir containing an oil, whereby the frozen medium sublimates from a solid to a sublimated gas, whereby the excess sublimated gas migrates from the freeze dryer into the oil in the vacuum pump to form a particulate gas and water vapor mixed with the oil and trapped in the vacuum pump;
monitoring, through a reservoir sight glass, a predetermined level of the oil composition in the reservoir of the vacuum pump;
waiting a predetermined time for the vacuum pump to cool;
switching the transfer switch to a filter mode;
opening an oil flow control valve;
circulating the oil throughout the vacuum pump, whereby the pressure generated by the vacuum pump enables flowage of the oil;
at least partially collecting condensation and water vapor that evaporates from the oil through an exhaust hose;
at least partially collecting, in a sedimentary filter, rust, particulates, and water from the oil;
at least partially collecting, in a coalescing filter, water vapor and the particulate gas;
coalescing, in the coalescing filter, the water vapor, and the particulate gas into oil, water, and particulates, whereby the particulates in the particulate gas are at least partially separated from the gas;
separating, in the coalescing filter, the oil from the water and the particulates, whereby the oil is rejuvenated;
injecting clean air through a vent and an exhaust hose into the rejuvenated oil;
at least partially collecting, in the sedimentary filter, water from the rejuvenated oil;
returning, through a return hose, the rejuvenated oil to the reservoir of the vacuum pump; and
turning the vacuum off and allowing the remaining oil in the static system to return to the reservoir of the vacuum pump.

2. The method of claim 1, whereby the pressure generated by the vacuum pump occurs as a series of pump vanes turn and cause suction at an intake block, pulling clean air from the vent and oil that has been pushed through the coalescing filter, through the return hose to the pump vanes and the exiting through a series of reed valves into the oil reservoir.

3. The method of claim 1, further comprising a step of switching a transition switch to a freeze drying mode and a step of freezing a medium in a freeze dryer.

4. The method of claim 1, further comprising a step of closing the oil flow control valve.

5. The method of claim 4, further comprising a step of switching the transition switch to the freeze drying mode.

6. The method of claim 1, further comprising a step of providing power for operation of the freeze drying mode with a first power source.

7. The method of claim 1, further comprising a step of providing power for operation of the filter mode with a second power source.

8. The method of claim 3, further comprising a step of heating the medium while evacuating pressure from the freeze dryer.

9. The method of claim 1, further comprising a step of draining, through a petcock drain, collected rust, particulates, and water in the sedimentary filter.

10. The method of claim 1, further comprising a step of returning the rejuvenated oil to the reservoir in the vacuum pump through a filter drain.

11. The method of claim 1, further comprising a step of enabling passage of air and oil composition through a reed valve in the vacuum pump to generate pressure in the reservoir, whereby the pressure enables flowage of the air and oil composition through the vacuum pump, the sedimentary filter, and the coalescing filter; whereby the coalescing filter coalesces water vapor, and the coalesced water vapor is trapped in the sedimentary filter or evaporates through the vent and the sublimated gas is coalesced back into the solid and trapped by the sedimentary filter.

12. The method of claim 1, wherein the step of waiting a predetermined time for the vacuum pump to cool, comprises cooling to a predetermined temperature.

13. The method of claim 1, wherein the step of circulating the oil composition between the freeze dryer and the vacuum pump, further comprises using the vacuum pump to move the oil composition through the coalescing filter by pushing the oil composition and clean air from an outer core of the coalescing filter and through the vacuum pump at pressure less than 2500 Torr.

14. A method for filtering an oil composition in a vacuum pump used with a freeze dryer, the method consisting of:
freezing a medium in a freeze dryer;
switching a transition switch to a freeze drying mode;
evacuating, with a vacuum pump, pressure from the freeze dryer through a vacuum hose, the vacuum pump comprising a reservoir containing an oil, whereby the frozen medium sublimates from a solid to a sublimated gas, whereby the sublimated gas migrates from the freeze dryer into the oil in the vacuum pump to form a particulate gas mixed with the oil;
heating the medium while evacuating pressure from the freeze dryer;
monitoring, through a reservoir sight glass, a predetermined level of the oil composition in the reservoir of the vacuum pump;
waiting a predetermined time for the vacuum pump to cool to a predetermined temperature;
switching the transfer switch to a filter mode;
opening an oil flow control valve;
circulating the oil composition throughout the vacuum pump, a coalescing filter and a sedimentary filter at a predetermined pressure, whereby pressure generated by the vacuum pump enables flowage of the oil composition;
at least partially collecting condensation and water vapor that evaporates from the oil through an exhaust hose;
at least partially collecting, in the sedimentary filter, rust, particulates, and water from the oil;
at least partially collecting, in the coalescing filter, water vapor and the particulate gas;
coalescing, in the coalescing filter, the water vapor, and the particulate gas into oil, water, and particulates, whereby the particulates in the particulate gas are at least partially separated from the gas;
separating, in the coalescing filter, the oil from the water and particulates, whereby the oil is rejuvenated for use with the oil composition;
injecting clean air through a vent and an exhaust hose into the rejuvenated oil;
at least partially collecting, in the sedimentary filter, water from the rejuvenated oil;
returning, through a return hose, the rejuvenated oil to the reservoir of the vacuum pump;
turning the vacuum off and allowing the remaining oil in the static system to return to the reservoir of the vacuum pump;
closing the oil flow control valve; and
switching the transition switch to the freeze drying mode.

15. A filter system for filtering an oil composition in a vacuum pump used with a freeze dryer, the system comprising:
a vacuum pump comprising a check valve and a reservoir containing an oil composition, the vacuum pump operationally connected to a freeze dryer through a vacuum hose, the vacuum pump evacuating pressure from the freeze dryer;
a sedimentary filter;
a coalescing filter comprising a core;
an oil recirculation hose circulating the oil composition from the reservoir through the sedimentary filter and into the core of the coalescing filter;
wherein the coalescing filter at least partially collects water vapor and the particulate gas, the coalescing filter further coalescing the water vapor, and the particulate gas into oil, water, and particulates, whereby the particulates in the particulate gas are at least partially separated from the gas, the coalescing filter further separating the oil from the water and particulates, whereby the oil is rejuvenated for use with the oil composition;
a reed valve operational in the vacuum pump, the reed valve enabling passage of the oil composition and clean air for generating pressure in the reservoir of the vacuum pump;
an oil control valve controlling the generated pressure to a predetermined pressure during circulation of the oil composition, the oil control valve further maintaining the oil composition at a predetermined level in the vacuum pump;
a filter drain enabling selective passage of the rejuvenated oil from the coalescing filter to the reservoir in the vacuum pump;
a vent enabling passage of the clean air into the rejuvenated oil;
an exhaust hose in communication with the vent, the exhaust hose carrying the clean air to the rejuvenated oil;
a return hose returning the rejuvenated oil to the reservoir of the vacuum pump;
a transfer switch for switching the system between a freeze drying mode and a filter mode;
a first power source powering the system in the freeze drying mode; and
a second power source powering the system in the filter mode.

16. The system of claim 15 wherein the sedimentary filter at least partially collects rust, particulates, and water from the oil composition, the sedimentary filter is a bi-directional filter comprising a petcock drain for selectively draining the rust, particulates, and water from the system.

17. The system of claim 15 wherein the coalescing filter is a 0.3 micron filter that causes the trapped water and particulates to coalesce back to water and particulate as the trapped water and particulates pass through the filter element.

18. The system of claim 15 further comprising a return hose for returning the oil composition to the vacuum pump reservoir from the coalescing filter into the check valve of the vacuum pump through a series of a pump vanes and pump reed valves into the reservoir of the vacuum pump.

19. The system of claim 15 further comprising a reservoir sight glass for viewing a predetermined level of oil composition in the reservoir of the vacuum pump; wherein the level and pressure of oil are controlled by the oil flow control valve at a pressure less than about 2500 Torr.

20. The system of claim 19 further comprising an oil drain valve fluidly coupled to the vacuum pump, the oil drain valve discharging the oil composition from the vacuum pump reservoir if the predetermined level of the oil composition rises above the reservoir sight glass.
